(19) United States
(12) Patent Application Publication
(10) Pub. No.: US 2017/0159323 A1
(43) Pub. Date: Jun. 8, 2017

(54) STAKE PULLER

(71) Applicant: JESSE GRAVES, Zachary, LA (US)

(72) Inventor: JESSE GRAVES, Zachary, LA (US)

(21) Appl. No.: 14/962,994

(22) Filed: Dec. 8, 2015

(51) Int. Cl. E04H 17/26; B25C 11/00

(52) U.S. Cl. CPC E04H 17/265; B25C 11/00

(57) ABSTRACT

The present invention is an apparatus for removing stakes from the ground is disclosed which is small, is able to be operated by a single user, causes minimal impact to the environment surrounding its use, is efficient, and which employs a gear-reduced mechanism and a specially-designed engaging plate to accomplish these objectives.

### BACKGROUND OF THE INVENTION

The present invention relates to an apparatus for extracting stakes from the ground.

Stakes have been a crucial component of many different devices and technologies, providing the stationary support required by items such as property markers, tethering points, guy wires and very commonly, tents. To afford a user the maximum benefit of the stakes' anchoring properties, the stakes must be driven into the ground, often at great depths, in order to provide the necessary anchoring security. A result of this deep-seating process is a stake that is anchored very well, and with a great deal of friction between the stake and surrounding ground. While beneficial (and quite necessary) when the stake is being used as an anchor point, this friction and the depth of drive of these stakes makes removing these anchors arduous and especially time-consuming.

To remove these stakes, many methods have been utilized, most of which simply involve brute force being applied in an effort to back the stakes out of the position they were driven into, or digging out the stakes, which is destructive to the surrounding areas, in addition to being time-consuming. Devices have long been used to try and aid in this endeavor, some which will start the stakes' movement by breaking that initial friction through the use of machinery or leverage, but many still require a fair amount of effort, and any device that is sufficiently powerful and large enough to forcibly remove these stakes is generally invasive (which is not an ideal situation when the condition of the ground is to be preserved) or large, cumbersome and expensive.

While these brute-force approaches may provide a user with a means to remove stakes from the ground, there are instances where the ground must remain in largely undisturbed condition, or where large machinery simply cannot be used, for reasons such as aesthetics or access. Thus, it is often not only preferable from a convenience standpoint, but may very well be required by circumstances, to have a smaller tool to have on a jobsite. Also, operators sometimes may not have the stature or numbers to pull up a deeply-rooted stake, or the volume of stakes is simply too high for a small number of users to extract in a timely fashion.

Clear downsides to the current mode of extracting stakes exist. Firstly, a solution that can be easily employed by a small number, or even a single user has not been employed. Secondly, even while the common method of extracting stakes will often work eventually, no known low-invasive means of removing stakes rapidly, particularly tent stakes and other similarly driven stakes which utilize a stake boss. This leaves the user to attempt brute force methods of removal, or other tools and methods. For those methods employed by others to extricate these stakes, the process is overwrought and typically not a easily-employed system, and is therefore inherently subject to increased user fatigue, failure, ground damage, tool damage, increased expense and increased time and financial investment.

The consequence of these issues is the inherent ineffectiveness of the current state of the art for removing stakes, especially those utilizing a stake boss. The absence of a solution which provides a quick, easy method of extracting stakes has yet to be developed. The present invention provides a simple, secure and quickly-employed apparatus for stakes to be removed from the ground. The present invention of a stake puller is thus a novel, needed and functional answer to the problems in the field relating to stake removal.

All of these aspects of the current state of stake removal technology lead to an increased need for a revised method of implementation with minimized cost and complexity, all of which the present invention addresses.

### OBJECTS OF THE INVENTION

One object of the invention is to provide an apparatus for removing stakes from the ground.

An additional object of this invention is to provide an apparatus for removing stakes from the ground that is easy to use.

Another object of this invention is to provide an apparatus for removing stakes from the ground that is compact.

Yet another object of this invention is to provide an apparatus for removing stakes from the ground that can be employed by a single user.

Still another object of this invention is to provide an apparatus for removing stakes from the ground that is minimally invasive to the ground from which such stakes are removed.

Other objects and advantages of this invention shall become apparent from the ensuing descriptions of the invention.

### SUMMARY OF THE INVENTION

According to the present invention, an apparatus for removing stakes from the ground is disclosed which is small, is able to be operated by a single user, causes minimal impact to the environment surrounding its use, is efficient, and which employs a gear-reduced mechanism and a specially-designed engaging plate to accomplish these objectives.

### BRIEF DESCRIPTION OF THE DRAWINGS

The accompanying drawings and figures illustrate an embodiment of this invention. However, it is to be understood that this embodiment is intended to be neither exhaustive, nor limiting of the invention. They are but examples of some of the forms in which the invention may be practiced.

FIG. 1 is a perspective view of the stake puller engaging a stake boss.

FIG. 2 is a perspective view of the stake puller.

FIG. 3 is an exploded view of the retaining dogs of the stake puller.

FIG. 4 is a front view of the retaining dogs of the stake puller and engaging plate.

FIG. 5 is a side view of the retaining dogs of the stake puller and engaging plate.

### DETAILED DESCRIPTION OF EXEMPLARY EMBODIMENTS

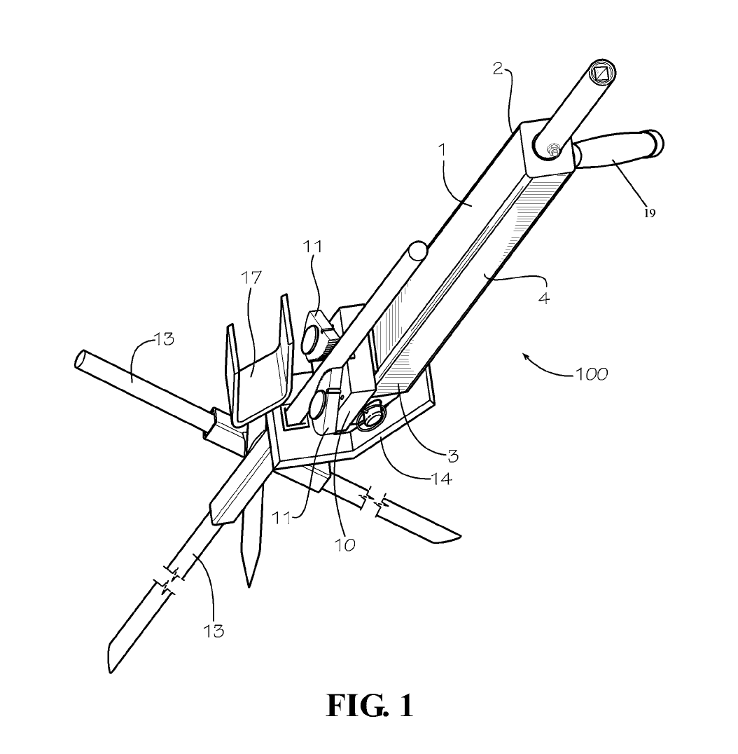

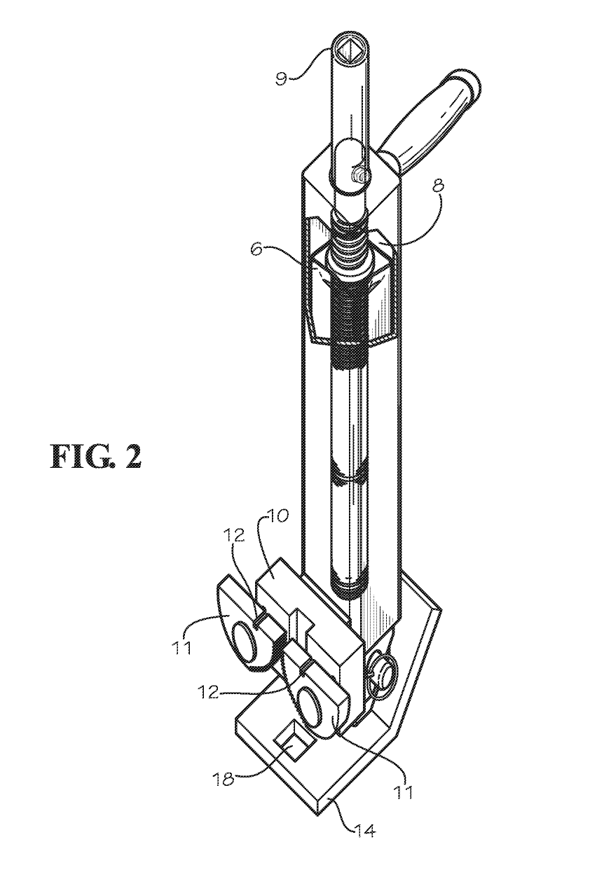

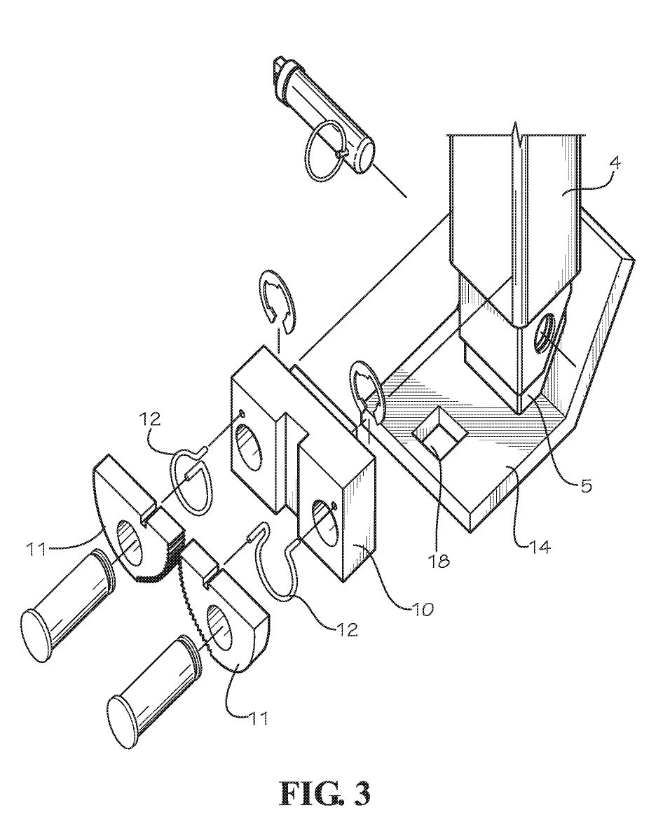

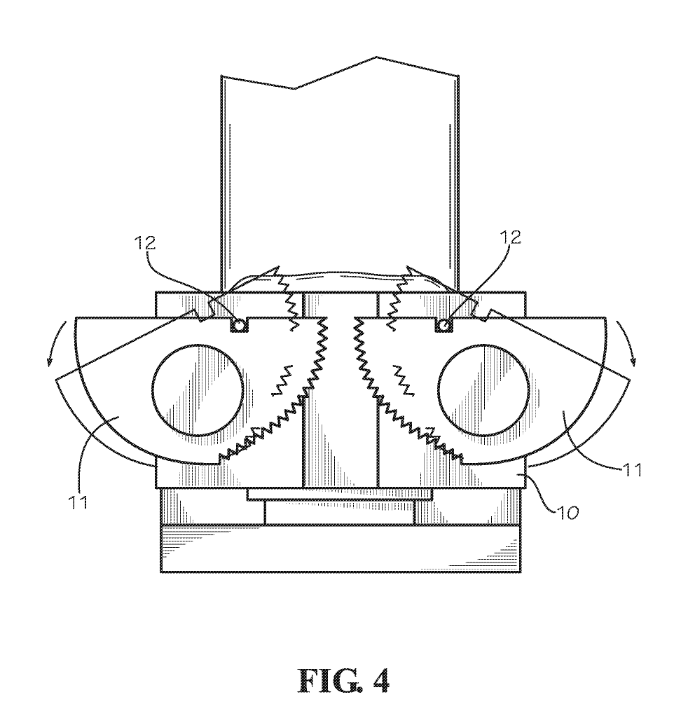

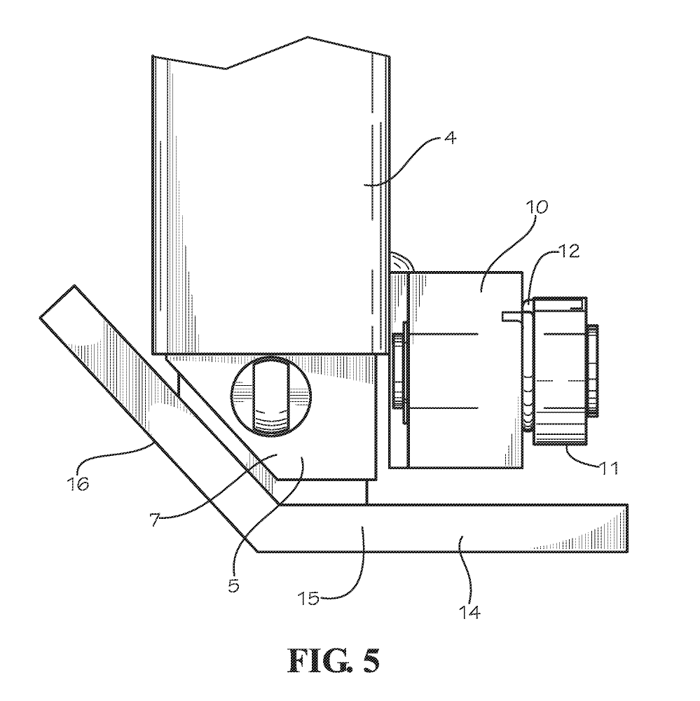

Without any intent to limit the scope of this invention, reference is made to the figures in describing the various embodiments of the invention. FIGS. 1 through 5 depict various aspects of exemplary embodiments of the present invention.

The present invention relates to stake puller 100 as pictured in FIGS. 1 through 5. Stake puller 100 has a main jack assembly 1, having first opposite end 2 and second opposite end 3 and being formed from outer sleeve 4. Outer sleeve 4 forms a cavity within which inner sleeve 5 is configured to fit. Inner sleeve 5 also has a first opposite end 6 and second opposite end 7. Inner sleeve 5 is shaped to be in a slidable and telescopic configuration within outer sleeve 4.

Within outer sleeve 4 is also housed gear reduction assembly 8, which is affixed near said first opposite end 2 of outer sleeve 4. Operatively attached to gear reduction assembly 8 is input shaft 9, which is utilized to permit manual input of torque force which is then converted by gear reduction assembly 8 into linear force directed out of outer sleeve 4 and against the telescoping inner sleeve 5, thus extending or collapsing nested inner sleeve 5 within or out of outer sleeve 4.

Near second opposite end 3 and preferably on a vertical face of outer sleeve 4 is affixed dog mounting plate 10. A plurality of dogs 11 are mounted to mounting plate 10, and are spaced to accommodate stake 13, and are configured to permit only one-way linear movement of a stake placed between dogs 11. Springs 12 are utilized to keep dogs 11 in physical communication with any stake 13 that is placed between dogs 11.

Engagement plate 14 is operatively affixed to second opposite end 7 of inner sleeve 5, and wherein engagement plate 14 is shaped to form at least two planar surfaces 15, 16 and wherein at least two of said planar surfaces 15, 16 are in a relationship of 120-140 degrees to one another and further configured to engage the face of stake boss 17. At least one planar surface 15, 16 is also formed to accommodate a stake with an engagement orifice 18, typically the most horizontal planar surface 15 when stake puller 100 is in a typical upright fashion. Handle 19 can also be employed to aid in using the device.

In operation, then, stake puller 100 is set on stake boss 17 and wherein engagement orifice 18 is engaged on stake boss 17 and stake 13 is fed up through and between dogs 11 as far as possible. Engagement plate's 14 unique planar surfaces 15, 16 here permit a substantially perpendicular arrangement of engagement orifice 18 and first planar surface 15 with the stake boss while simultaneously permitting a parallel relationship with the ground relative to second planar surface 16.

Springs 12 will apply pressure on dogs 11 sufficient to prevent reverse motion of stake 13 relative to the ground. Once thusly mounted, torque force is applied to input shaft 9 and in turn, gear reduction assembly 8. This causes inner sleeve 5 to telescope proud of outer sleeve 4, permitting outer sleeve 4, its attached mounting plate 10, and thus dogs 11 and the captured stake 13 to be pulled upward as inner sleeve 5 and attached engagement plate 14 are forced downward. This upward pulling of stake 13 results in the extrication of stake 13. The input force at input shaft 9 is multiplied by gear reduction assembly 8 enabling a relatively low power torque input to be converted into much stronger linear energy that is used to extricate stake 13.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A stake puller comprising:
a. a jack assembly having first and second opposite ends and formed from an outer sleeve further forming a cavity within which an inner sleeve having first and second opposite ends is configured to engage said outer sleeve in a slidable, telescopic configuration;
b. a gear reduction assembly operatively affixed between said first opposite end of said outer sleeve and said first opposite end of said inner sleeve, wherein said gear reduction assembly further comprises an input shaft for the operation of said gear reduction assembly;
c. a dog mounting plate affixably attached to a vertical face of said second end of said outer sleeve;
d. a plurality of dogs operatively attached to said dog mounting plate and configured to permit one-way travel of a stake placed betwixt said plurality of dogs; and
e. an engagement plate operatively affixed to said second opposite end of said inner sleeve, and wherein said engagement plate is shaped to form at least two planar surfaces and wherein at least two of said planar surfaces are in a relationship of 120-140 degrees and configured to engage the face of stake boss.

2. The stake puller of claim 1, further comprising at least one handle mounted in a perpendicular relationship near said first opposite and of said outer sleeve.

3. The stake puller of claim 1, further comprising ridges on the faces of said dogs which are configured to engage said stake.

4. The stake puller of claim 1, wherein said engagement plate is formed to accommodate the cross-section of said stake.
